(19) United States
(12) Patent Application Publication
(10) Pub. No.: US 2017/0269592 A1
(43) Pub. Date: Sep. 21, 2017

(54) Use of Unmanned Aerial Vehicles for NDT Inspections

(71) Applicant: Oceaneering International, Inc., Houston, TX (US)

(72) Inventor: David Wesley Weaver, Severna Park, MD (US)

(73) Assignee: Oceaneering International, Inc., Houston, TX (US)

(21) Appl. No.: 15/462,557

(22) Filed: Mar. 17, 2017

Related U.S. Application Data
(60) Provisional application No. 62/310,484, filed on Mar. 18, 2016.

(51) Int. Cl. G05D 1/00; G01N 21/952; H04N 7/18; G05D 1/08; G06K 9/00; G01N 21/88; B64C 39/02

(52) U.S. Cl. CPC G05D 1/0038; G01N 21/8803; G01N 21/952; B64C 39/024; G05D 1/0808; G06K 9/0063; H04N 7/183; G01N 2201/101; B64C 2201/12; B64C 2201/108; B64C 2201/18; B64C 2201/146

(57) ABSTRACT

An unmanned aerial vehicle (UAV), comprising one or more motors, one or more non-destructive testing data collectors, and an electro-magnet, may be used to inspect a structure to which it can magnetically attach by having the UAV approach the structure and activating the electro-magnet when the UAV is a predetermined distance to the structure to be inspected. Once maneuvered close enough to the structure to allow the electro-magnet to magnetically attach to the structure to be inspected, the UAV may be secured against the structure using the electro-magnet proximate an area to be inspected such that the non-destructive testing data collector is disposed proximate the area to be inspected. Data may then be collected using the non-destructive testing data collector.

### RELATION TO OTHER APPLICATIONS

This application claims the benefit of U.S. Provisional Patent Application 62/310,484 titled “Use Of Unmanned Aerial Vehicles For NDT Inspections” filed on Mar. 18, 2016.

### FIELD OF THE INVENTION

Unmanned aerial vehicles (UAVs) are used for visual inspection of offshore equipment. Access for more in-depth inspections requires the use of rope access teams which increases the risk to personnel, takes a greater amount of time with increased cost, and is limited by weather. The ability of the UAV to perform non-destructive testing (NDT) inspections normally performed by rope access teams will reduce personnel risk, be accomplished quicker resulting in lower cost overall.

### FIGURES

The figures supplied herein illustrate various embodiments of the invention.

FIG. 1 is a view in partial perspective of an exemplary embodiment of the claimed invention in relation to a structure to be inspected; and

FIG. 2 is a view in partial perspective of an exemplary embodiment of the claimed invention.

### DESCRIPTION OF VARIOUS EMBODIMENTS

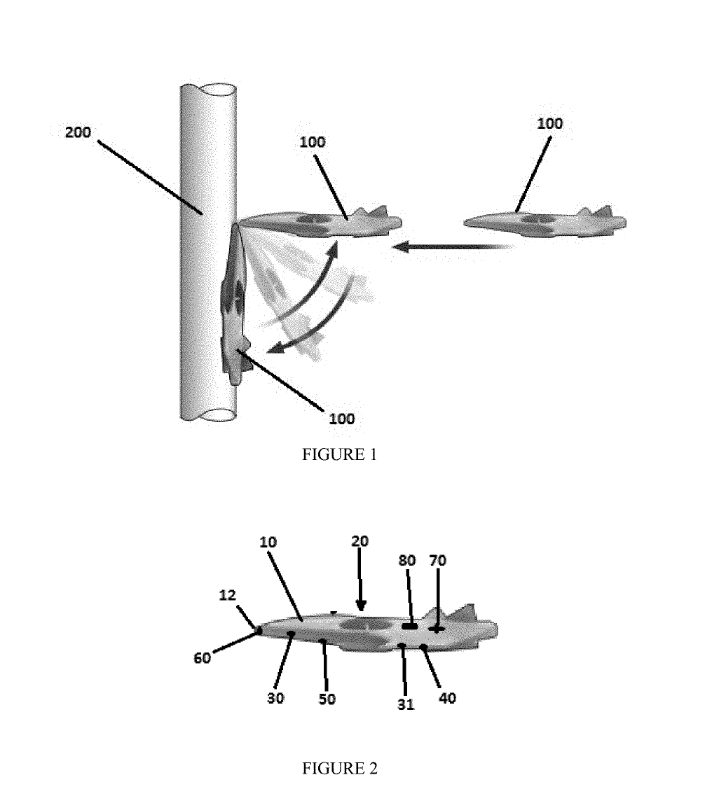

Referring to FIGS. 1 and 2, unmanned aerial vehicle (UAV) 100 is useful for conducting a non-destructive testing (NDT) inspection. Although illustrated as a fixed wing UAV, UAV 100 may be any appropriate design such as one using multiple propulsion systems.

UAV 100 typically comprises housing 10, which typically comprises airframe 12; motor 20, which may be attached to or disposed at least partially within housing 10 or attached to or disposed at a convenient location; one or more sensors 30 and/or probes 31 mounted to airframe 12, e.g. to underside 11; one or more navigation sensors 40, which can comprise cameras; one or more non-destructive testing data collectors 50 mounted to airframe 12, e.g. underside 11; one or more electro-magnets 60 mounted on, within, or partially within airframe 12; and radio frequency (RF) link 70. Controller 80 is typically disposed at least partially if not completely within housing 10 and is operatively in communication with sensors 30 and/or probes 31, navigation sensors 40, non-destructive testing data collectors 50, electro-magnets 60, and RF link 70.

Although illustrated with a single, central propulsion system, more traditional propulsion systems comprising one or more motors attached to one or more propellers and/or one or more air propulsion units may be used for motor 20. Motor 20 may comprise an electric motor, a fuel cell driven motor, a gas motor, a propeller, a jet motor, or the like, or a combination thereof located at a convenient location such as at a rear portion of housing 10 for fixed wing UAVs or at peripheries of multiple propulsion UAVs. In certain embodiments, housing 10 comprises motor port 21 through housing 21 and motor 20 is disposed such that air flow manipulated by motor 20 is allowed through motor port 21.

Typically, sensor 30 and/or probe 31 comprise a non-destructive testing (NDT) sensor or probe.

If present, one or more navigation sensors 40 are typically of a sort which can be used to aid an operator in maneuvering UAV 100 into position and/or conducting visual inspections to compliment other inspections, such as but not limited to cameras.

NDT testing data collector 50 typically comprises an NDT sensor and/or an NDT probe.

Electro-magnets 60 may be mounted on or within housing 10 proximate on nose 12, proximate a rear portion of UAV 100, or a combination thereof. In non-fixed wing UAVs, electro-magnets 60 may be mounted at any advantageous site.

RF link 70 is typically connected to housing 10 and operatively in communication with one or more navigation sensors 40 and NDT testing data collector 50, e.g. it may be connected about an outer portion of housing 10, at least partially within housing 10, or completely within housing 10.

In certain embodiments, one or more position transponders 80 such as an ADS-B out transponder may be disposed in an advantageous position in, on, or partially within housing 10 to broadcast a current position of UAV 100 such as to nearby aircraft for de-confliction purposes.

In the operation of a preferred embodiment, referring additionally to FIG. 1, structure 200 which comprises a magnetically attachable surface area may be inspected using UAV 100, as described above, by using one or more motors 20 to maneuver, e.g. fly, UAV 100 proximate structure 200 to be examined. Once UAV is sufficiently close to structure 200, electro-magnet 60 may be activated as UAV 100 approaches structure 200 and UAV 100 maneuvered close enough to structure 200 to allow electro-magnet 60 to attach and secure UAV 100 to structure 200.

As will be apparent to those of ordinary skill in the UAV arts, controller 70 is of a sort, e.g. a computer or programmable field array logic or the like, which is capable of operatively being in communication with and controlling sensors 30 and/or probes 31, navigation sensors 40, non-destructive testing data collectors 50, electro-magnets 60, and RF link 60, such as via stored instructions, instructions received in real-time from an operator via RF link 60, or the like, or a combination thereof.

Motor 20 may then be used to further position housing 10 against structure 200 proximate an area to be inspected such that non-destructive testing data collector 50 is disposed proximate the area to be inspected. The predetermined function may comprise maneuvering UAV 100 into position, conducting a sensor based inspection of structure 200, e.g. a visual inspection or the like, to compliment a non-destructive testing inspection of structure 200, or the like, or a combination thereof. In such cases, navigation sensor 40 may be used to aid an operator in maneuvering UAV 100 into position and/or to help conduct an inspection to compliment the NDT inspections.

Once in place, data may be collected using non-destructive testing data collector 50, sensor 30, and/or probe 31.

Collected data may be transmitted to a remote site and/or operator such as via RF link 60.

Once a satisfactory set of data are obtained, one or more motors 20 may be used to bring UAV 100 back to a substantially horizontal position. At that time, i.e. when sufficient data are collected, electro-magnet 60 may be deactivated to allow UAV 100 to leave structure 200 and one or more motors 20 used to fly UAV 100 away from structure 200.

If motor 20 comprises a rear propeller, motor 20 may be used to further position housing 10 against structure 200 by rotating the rear propeller to provide sufficient thrust to further position housing 10 against structure 200 such as proximate the area to be inspected. As needed, thrust of motor 20, e.g. of its propeller, may be reversed to bring UAV 100 to a substantially horizontal position once satisfactory data are obtained.

The foregoing disclosure and description of the inventions are illustrative and explanatory. Various changes in the size, shape, and materials, as well as in the details of the illustrative construction and/or an illustrative method may be made without departing from the spirit of the invention.

What is claimed is:

1. An unmanned aerial vehicle (UAV), comprising:
a. a housing;
b. a motor attached to the housing;
c. a non-destructive testing data collector mounted to an underside of the housing;
d. an electro-magnet mounted proximate a predetermined section of the housing;
e. a navigation sensor attached to the housing;
f. a controller operatively in communication with the motor, the electro-magnet, and the camera; and
g. a radio frequency (RF) link connected the housing and operatively in communication with the controller, the camera, and the data collector.

2. The unmanned aerial vehicle (UAV) of claim 1, wherein the motor comprises a propeller.

3. The unmanned aerial vehicle (UAV) of claim 1, wherein the non-destructive testing data collector comprises an NDT sensor.

4. The unmanned aerial vehicle (UAV) of claim 1, wherein the non-destructive testing data collector comprises an NDT probe.

5. The unmanned aerial vehicle (UAV) of claim 1, wherein the radio frequency (RF) link is disposed at least partially within the housing, disposed about an outer surface of the housing, or disposed completely within the housing.

6. A method of inspecting a structure using an unmanned aerial vehicle (UAV) comprising a housing, a motor attached to the housing a predetermined section of the housing, a non-destructive testing data collector mounted to an underside of the housing, an electro-magnet mounted proximate a predetermined section of the housing, a navigation sensor attached to the housing, a controller operatively in communication with the motor, the electro-magnet, and the navigation sensor, and a radio frequency (RF) link connected to the housing and operatively in communication with the controller, the camera, and the data collector, the method comprising:
a. using the motor to maneuver the UAV proximate a structure to be examined, the structure comprising a magnetically attractive surface area;
b. maneuvering the UAV close enough to the structure to allow the electro-magnet to magnetically attach to the structure to be inspected;
c. activating the electro-magnet when the UAV is a predetermined distance from the structure to be inspected;
d. securing the UAV against the structure using the electro-magnet;
e. using the motor to further position the UAV housing against the structure proximate an area to be inspected such that the non-destructive testing data collector is disposed proximate the area to be inspected; and
f. collecting data using the non-destructive testing data collector.

7. The method of claim 6, further comprising transmitting the collected data via the RF link.

8. The method of claim 6, further comprising using the navigation sensor to aid an operator to perform a predetermined function.

9. The method of claim 8, wherein the predetermined function comprises maneuvering the UAV into position or conducting a navigation sensor based inspection of the structure to compliment a non-destructive testing inspection of the structure.

10. The method of claim 6, further comprising using the motor to bring the UAV back to a substantially horizontal position once a satisfactory reading is obtained.

11. The method of claim 6, wherein the motor comprises a propeller attached to a predetermined position of the UAV, the method further comprising using the motor to further position the UAV housing against the structure proximate the area to be inspected by rotating the propeller to provide sufficient thrust to further position the UAV housing against the structure proximate the area to be inspected.

12. The method of claim 11, further comprising reversing the thrust of the propeller to bring the UAV to a substantially horizontal position once a satisfactory reading is obtained.

13. The method of claim 6, further comprising:
a. deactivating the electro-magnet to allow the UAV to leave the structure after data are collected; and
b. using the motor to fly the UAV away from the structure once the UAV is no longer attached to the structure.
